(19) United States
(12) Patent Application Publication
(10) Pub. No.: US 2006/0045724 A1
(43) Pub. Date: Mar. 2, 2006

(54) Harvested crop loading method and apparatus

(75) Inventors: J. Kevin Alsobrook, Yuma, AZ (US); James Aikins, Modesto, CA (US)

Correspondence Address: DUCKOR SPRADLING METZGER, 401 WEST A STREET, SUITE 2400, SAN DIEGO, CA, 92101-7915, US

(73) Assignee: Fresh Innovations, LLC

(21) Appl. No.: 10/933,087

(22) Filed: Sep. 2, 2004

(51) Int. Cl. B65G 57/00

(52) U.S. Cl. 414/789.7

(57) ABSTRACT

A method and apparatus as disclosed relate to harvested crop loading apparatus and method for loading individual containers with harvested crops such as green onions, on vehicle means. The method and apparatus includes multiple stations including a receiving station, a loading station, and a stacking station on the vehicle means. A conveyor system interconnects at least certain ones of the stations such as the receiving station, the loading station and the stacking station to translate the containers disposed along at least one predetermined path of travel on the vehicle means.

### FIELD OF THE INVENTION

The present invention relates in general to an apparatus and method for loading harvested crops into containers. It more particularly relates to such apparatus and method of loading harvested crops into individual containers being transported on vehicle means.

### BACKGROUND ART

There is no admission that the background art disclosed in this section legally constitutes prior art.

In the past, harvesting support vehicles have been provided that trail behind crop harvesters for transporting the harvested crops in individual containers. These harvesting support vehicles may be self propelled or pulled by the harvester, and are staffed with personnel who take empty containers and cause them to be filled with the crops being harvested. After the containers are filled, the personnel stack the filled containers onto pallets which are then moved to a pallet storage area at the back of the harvesting support vehicle for later unloading at a processing location.

### BRIEF DESCRIPTION OF THE DRAWINGS

The following is a brief description of the drawings:

FIG. 1 is a pictorial view of a harvesting support vehicle, which is constructed in accordance with an embodiment of the invention and which illustrates the right side, rear and top thereof;

FIG. 2 is a top plan view of the harvesting support vehicle of FIG. 1;

FIG. 3 is a pictorial view of the harvesting support vehicle of FIG. 1 illustrating the left side, rear and top thereof;

FIG. 4 is a reduced-scale side elevational view of the harvesting support vehicle of FIG. 1 illustrating it with the addition of an overhead cover or awning;

FIG. 5 is a pictorial view of a harvesting support vehicle which is constructed in accordance with another embodiment of the invention, and which illustrates the right side, front and top thereof;

FIG. 6 is a top plan view of the harvesting support vehicle of FIG. 5;

FIG. 7 is a pictorial view of a harvesting support vehicle of FIG. 5, illustrating the left side, front and top thereof;

FIG. 8 is an enlarged scale pictorial view of the harvesting support vehicle of FIG. 5, illustrating the on-board container stacking apparatus in operation;

FIG. 9 is a pictorial view of a container stacker apparatus of a harvesting support vehicle of FIG. 5, illustrating the stacking apparatus is a further stage of operation; and

FIG. 10 is a pictorial view of the harvesting support vehicle of FIG. 5, similar to FIG. 7 but from a different perspective.

### Detailed Description of Certain Embodiments of the Invention

A method and apparatus as disclosed relate to a harvested crop loading apparatus and method for loading individual containers on vehicle means with harvested crops such as green onions, spinach, baby leaf vegetables, and other. The method and apparatus includes multiple stations including a receiving station, a loading station, and a stacking station on the vehicle means. A conveyor system interconnects at least certain ones of the stations, such as the receiving station, the loading station and the stacking station to translate the containers disposed along at least one predetermined path of travel on the vehicle means.

According to one disclosed embodiment of the invention, a method of continually loading harvested crops into individual containers on a harvesting support vehicle means is provided. The method includes continually translating seriatim denested empty containers arranged in a series along a predetermined path of travel on the vehicle means to a loading station on the vehicle means. The method further includes continually loading containers with the harvested crops at the loading station and continually translating the loaded seriatim containers from the loading station to a stacking station on the harvesting support vehicle means along the predetermined path of travel where the loaded containers are continually stacked seriatim onto the harvesting support vehicle means.

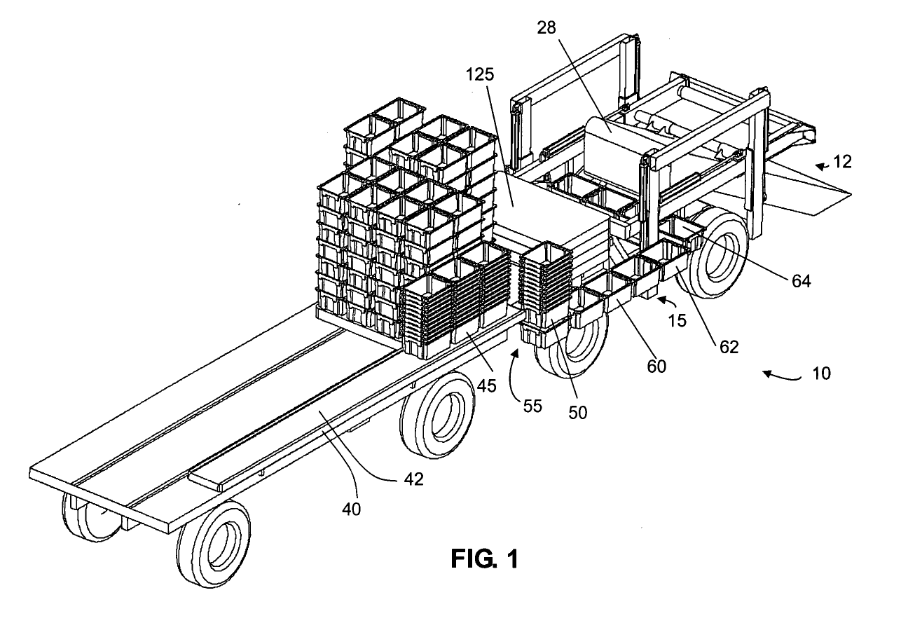

Referring now to the drawings, and more particularly to FIG. 1 thereof, there is shown a harvesting support vehicle 10 which a harvester 12 which may be similar to the one disclosed in U.S. Pat. No. 3,989,110. The harvester 12 is adapted to rapidly harvest a row of crops, such as green onions, spinach, baby leaf vegetables and other. It will become apparent to those skilled in the art that the support vehicle may also be self propelled, or may form a part of the harvester itself. Thus, when the term “vehicle means” is used herein, it refers either to a separate support vehicle which is either pulled or is self propelled, or to a single vehicle which serves both as a harvester and as a means of transporting containers.

According to the disclosed example, the harvesting support vehicle 10 may be self propelled and adapted to follow the harvester 12. The vehicle 10 may be capable of loading crops harvested at a high speed from harvester 12 into a plurality of containers.

In one embodiment of the present invention, the harvester support vehicle 10 may be coupled to the harvester 12 through a hitch 41 or other vehicle connection apparatus. The harvester support vehicle 10 may also include an empty container storage device 40 for storing nested empty containers 45.

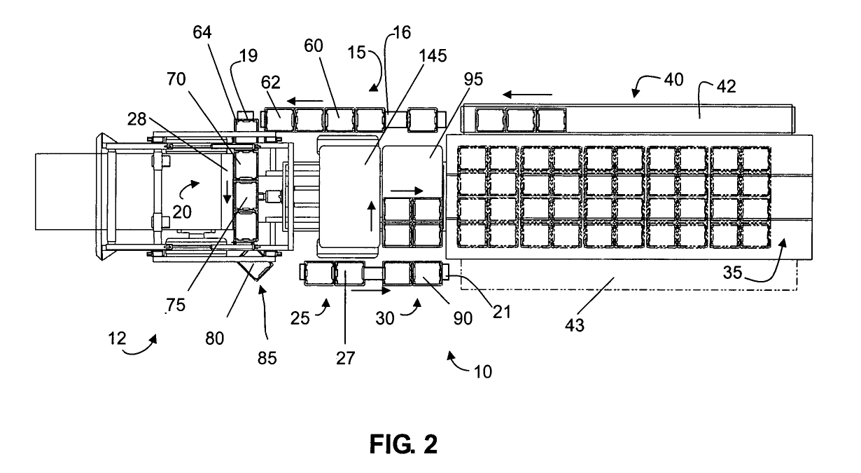

The harvesting support vehicle 10 includes a receiving station shown generally indicated at 15. In operation, the receiving station 15 continually receives seriatim individual denested empty containers such as a container 60, along a pre-determined path of travel on a continuous longitudinal conveyor system 16 (FIG. 2) disposed (not shown) on the harvester support vehicle 10 forwardly to a loading station 20 on the rear of the harvester 12 via a transverse conveyor system 19 (see FIG. 2) on the vehicle 10.

In this regard, empty open top containers are denested manually or by means (not shown), and translated manually or by conveyor means (not shown), to the conveyor system 16 at the receiving station 15. The conveyor system 16, as well as the conveyor system 19, may be a belt system, a roller system, a chain system or other.

With reference to FIG. 2, in operation at the loading station 20, harvested crops are continually loaded into containers such as a container 70 moving past the station 20, as hereinafter described in greater detail. The loaded containers, such as a container 75, are then continually translated seriatim from the loading station 20 to a stacking station 25 on the harvester support vehicle means 10 along the predetermined path of travel to a longitudinal continuous conveyor system 21, which may be similar to the conveyors 16 and 19. It should be understood that the containers may be translated between conveyors 16 and 19, and between the conveyors 19 and 21 either manually or by means (not shown).

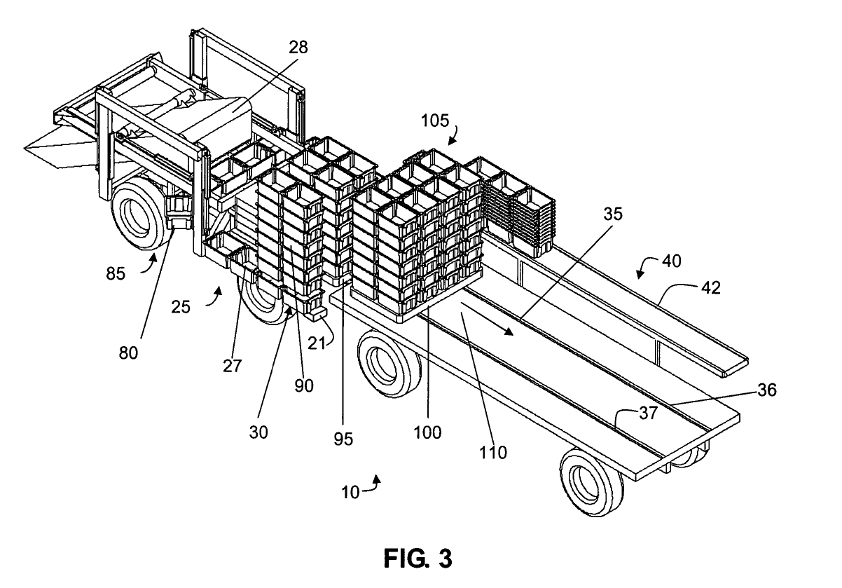

With reference to FIG. 3, in operations at the stacking station 25 filled containers such as container 27, are continually stacked, thereby creating a stack of loaded containers as indicated at 90. The stacks of loaded containers, such as the stack 90, are then translated to a pallet loading station 30 where the stacks of loaded containers are then translated onto a pallet such as pallet 95 either manually or by means (not shown).

With reference to FIG. 1, on board the harvesting support vehicle 10, the empty container storage device 40 may include an empty container conveyor 42 for translating longitudinally forwardly, along a predetermined path of travel, a plurality of stacks of nested empty containers such as a stack of nested empty containers 45. The conveyor 42 may be similar to the conveyors 16, 19 and 21. The stacks of nested empty containers may be placed on the empty container conveyor 42 of the device 40 through an automatic system (not shown) or by a human worker (not shown). The empty container conveyor 42 then translates the stack of nested empty containers to the receiving station 15.

Considering now the receiving station in more detail and with reference to FIG. 1, a denesting station 55 may be provided at the entrance to the receiving station 15 and where empty nested containers are denested from a stack, such as the stack of empty containers 50, received from the empty container conveyor 42. At the denesting station 55, empty containers are continually denested and the empty containers such as denested empty containers 60 and 62 are placed on the conveyor system 16 at the station 15. The denested containers 60 and 62 are then continually translated seriatim and are arranged in a series along a predetermined path of travel on the continuous conveyor system 16 on the harvester support vehicle 10 for travel to the loading station 20. The denesting of the stacks of empty containers can either be accomplished manually or by means (not shown).

Considering the loading station 20 in more detail and with reference to FIG. 2 thereof, open top empty denested containers such as container 70 that have been translated from the receiving station 15 pass underneath a crop discharge device shown generally at 28 of the harvester 12 which may be similar to the one disclosed in U.S. Pat. No. 3,989,110. The crop discharge device 28 dispenses freshly harvested crops seriatim from the harvester 12 and dispenses the harvested crops (not shown) into the containers such as container 75 as it moves transversely in the direction of the arrow past the discharge end of the device 28. The crops are generally dispensed into the containers at a high rate of speed.

The filled container 75 continues to travel over a predetermined path on the continuing conveyor system 19 to a translation station 85 where a loaded container such as container 80 containing crops is translated to the stacking station shown generally at 25. The translation station 85 may either be a mechanical system or means (not shown), or include personnel who that perform the translation operation manually.

Considering now the stacking station 25 in more detail with reference to FIG. 3 thereof, the stacking station 25 receives loaded containers such as denested loaded container 27 where they are stacked to form a stack of loaded containers such as the stack 90. Stacks of loaded containers may include a predetermined number such, for example, as seven containers. Stacks of loaded containers are then translated along a predetermined path via the conveyor system 21 to a pallet loading station shown generally at 30 where stacks of loaded containers such as stack 90 are staged to be loaded onto an empty pallet such as a pallet 95 (see FIGS. 2 and 3).

After the pallet 95 is filled with stacked loaded containers such as the stack 90, a full pallet 100 of stacks of loaded containers, as shown generally at 105, is placed onto a pallet and container storage conveyor system 35. The conveyor 35 may be similar to the conveyors 16, 19, 21 and 42, and it is presently contemplated to be a pair of chain drives 36 and 37. The full pallet 100 containing a plurality of stacks of loaded containers 105, is then translated rearwardly via a pallet and container conveyor system 35 in the direction shown by the arrow 110 in FIG. 3.

After the pallet and container storage area 35 is filled with full pallets of filled containers, the harvester support vehicle may then be separated from the harvester 12, and then transferred to a crop processing location (not shown) under its own power or pulled by a tractor or other vehicle (not shown).

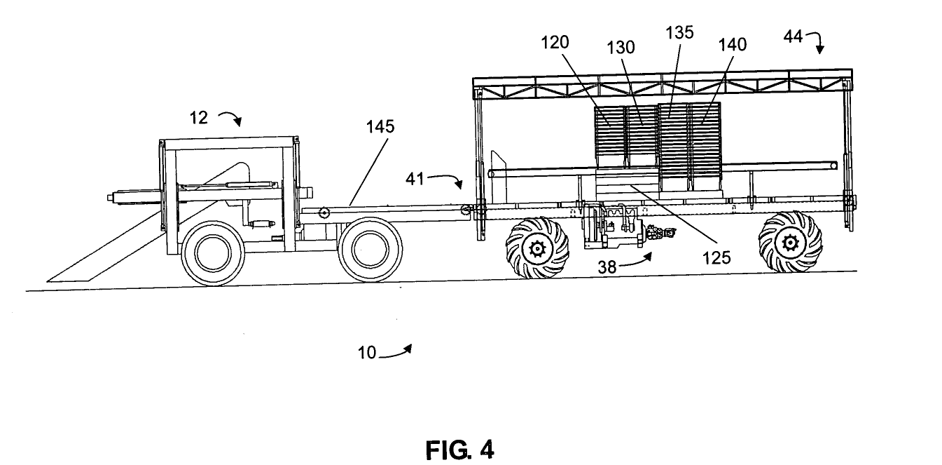

In the disclosed embodiment, the harvester support vehicle 10 may be releaseably attached to a the harvester 12 at 41 (FIG. 4). In this embodiment, the harvester support vehicle 10 may be self propelled, such as by an engine 38 (FIG. 4) and, thus, continually attempting to push the harvester 12 to move forwardly when the harvester is traveling forwardly during a harvesting operation.

After the support vehicle 10 is removed, it may then be replaced by another like support vehicle (not shown) and coupled to the harvester 12 or the harvester support vehicle means 10.

With reference to FIG. 4, the harvester support vehicle 10 is configured for storage of empty pallets as indicated at 125 and stacks of empty nested containers such as stacks 120, 130, 135 and 140. The configuration as shown in FIG. 4 is representative of a configuration before a harvesting operation is to commence.

In preparation for a harvesting operation, empty pallets 125 are translated to pallets staging area 145 as best shown in FIG. 2. The stacks of nested empty containers such as stacks 120, 130, 135 and 140 are then positioned on the conveyor 42 (FIG. 2). As shown in FIGS. 3 and 4, the empty container storage device 40 may be elevated to facilitate a later denesting operation. Also, the device 40 may extend longitudinally on the right side of the vehicle 10, and a second such device may be disposed on the left side of the vehicle in the area 43 indicated in FIG. 2 in broken lines. Also, as shown in FIG. 4, a covering or awning 44 may be provided on the vehicle 10.

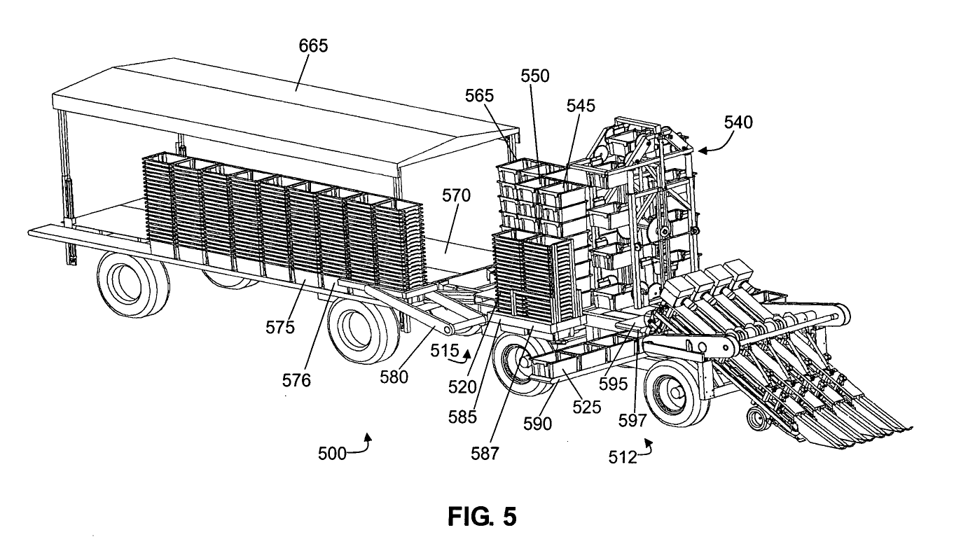

In another embodiment of the present invention with reference to FIG. 5, there is disclosed a harvesting support vehicle 500 which is adapted to be removably coupled to a harvester 512 for harvesting crops, such as green onions or others. The harvesting support vehicle 500 includes a receiving station shown generally at 515 for continually receiving stacks of empty nested containers such as a stack 520. The harvester support vehicle 500 is similar to the vehicle 10, but includes added mechanisms to facilitate the operation.

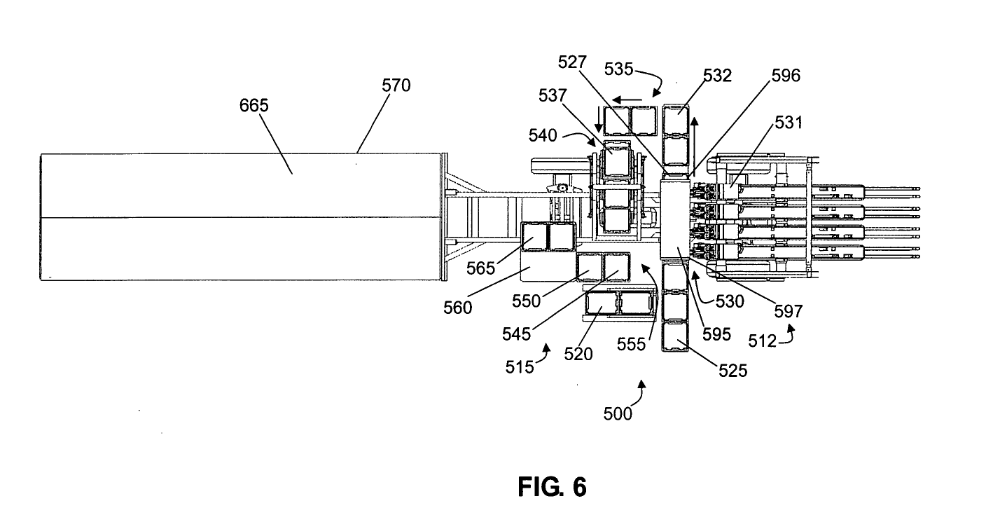

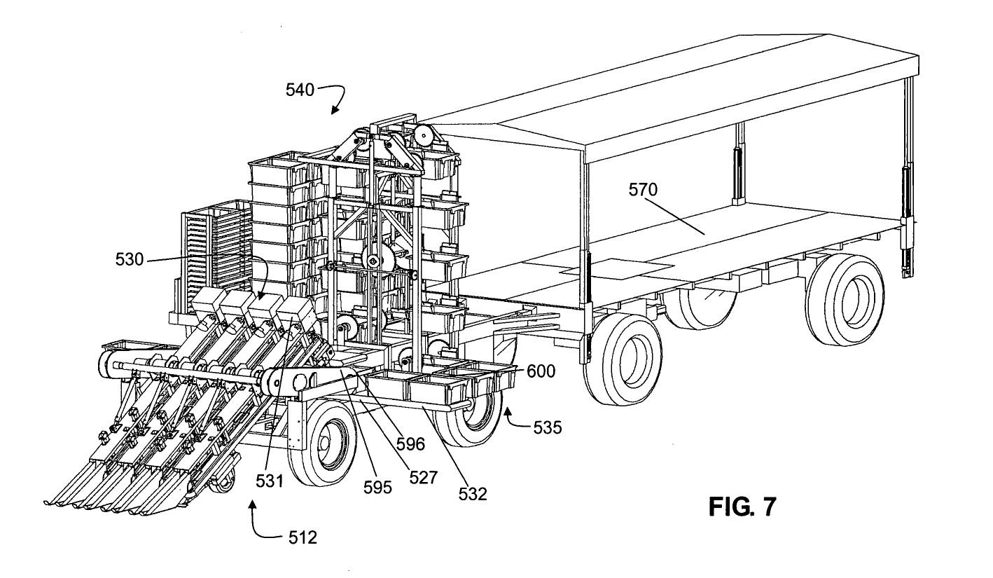

With reference to FIG. 6, denested empty containers such as a denested empty container 525 are translated one at a time from the receiving station 515 continually to a transverse conveyor system 590. the conveyor system 590 may be similar to the conveyor systems of FIGS. 1-4, and convey the containers to a loading station 530 along a pre-determined path of travel. As denested empty containers, such denested empty container 525, traverse the loading station 530, the denested empty containers are filled with harvested crops dispensed by a crop dispensing units, such as dispensing unit 531 (FIG. 7) of the harvester 512.

After the empty containers are filled with harvested crops, the containers filled with harvested crops such as a filled container 532 are continually translated seriatim from the loading station 530 rearwardly to a translation station 535. The translation station 535 receives filled containers such as the filled container 532, which are then translated to a container stacking apparatus 540 by moving transversely through a “U” turn translation operation. The “U” turn translation may be performed using a mechanical apparatus (not shown) or through a manual process utilizing human operators.

With reference to FIGS. 5 and 6, the container stacking apparatus 540 continually receives seriatim filled containers such as filled container 540 and stacks the filled containers on top of one another until a pre-determined amount of filled containers are stacked. Typically, there may be eight filled containers forming a stack such as filled container stacks 545 and 550 (FIG. 5).

Filled container stacks such as filled container stacks 545 and 550 are stored in a filled container stack staging area 555 as best shown in FIG. 6. After a sufficient quantity of filled container stacks are staged in the staging area 555, the filled container stacks such as stacks 545 and 550 are translated to an empty pallet such as pallet 560, either using a conveyor (not shown) or by other suitable techniques such as manually. After the pallet 560 is filled with filled container stacks, the pallet is translated to the pallet and container storage area 570 of the harvester support vehicle 500.

After the pallet and container storage area 570 is filled with a plurality of pallets each containing a plurality of filled container stacks, the harvester support vehicle 500 may be disconnected from the harvester 512 and transported to a food processing plant or other location for subsequent processing (not shown) either under its own power or pulled by a tractor. In this disclosed embodiment, the container stacking apparatus 540 and the loading station 530 are disposed on the harvester 512, but it is to be understood that these components may also be disposed on the support vehicle 500.

Considering now the receiving station 515, in more detail and in reference to FIG. 5, the vehicle 500 carries a plurality of nested empty container stacks such as nested empty containers 575 and 576. The containers are designed so that when they are empty they nest within one another thereby reducing the overall amount of space required for transportation. The containers may be conventional and contain a nesting and stacking feature such as when the containers are rotated 180 degrees about their vertical axis relative to another like container placed either above or below it, the containers will not nest but rather stack on top of each other such that when the containers are filled with crops, the containers may stack on top of one another without crushing the crops stored therein.

The nested empty container stacks such as the stacks 575 and 576, are disposed on the pallet and container storage are in alternating orientations of 180 degrees. For example, stack 575 may have an orientation about its vertical axis of zero degrees and stack 576 may have an orientation of 180 degrees about its vertical axis relative to the stack 575. In this configuration, as containers are denested as discussed below, adjacent containers will alternate in orientation so that they may be easily stacked and will not nest after being filled with crops.

In operation, the nested empty container stacks such as nested empty container stack 576 may be translated two stacks at a time to the receiving station 515 via a walking beam 580. After the pair of stacks of the nested empty containers are translated to the receiving station 515 they are then individually denested by means of a denesting apparatus 585. Denesting apparatus such as a denester bracket 587 may include a mechanical system to denest individual containers or may include a manual worker to denest the containers.

The denesting apparatus 515 may receive two stacks of nested empty containers, each stack having an opposite orientation about its vertical axis as described hereinbefore. The individual containers are denested one at a time from the bottom of the stacks. They are denested by alternating between the two stacks of orientation such that adjacent denested containers exiting the denesting apparatus alternate in orientation by 180 degrees to facilitate the subsequent stacking operation.

After individual containers are denested, a plurality of denested empty containers, such as denested empty container 525, are continually translated seriatim via the transverse container conveyor 590.

Considering now the loading station 530 in more detail and in reference to FIG. 7, loading station 530 is disposed on board the harvester 512 adjacent to the crop dispensing unit such as unit 531 of the harvester 512. The crop dispensing units continually dispense crops seriatim onto a transverse crop conveyor 595 which may be in the form of a continuous loop conveyor belt disposed above the transverse container conveyor 590. The transverse crop conveyor 595 includes an origin end 597 (FIG. 5) and a termination end 596 (FIG. 6). Thus, crops dispensed onto the transverse crop conveyor 595 travel from the origin end 597 to the termination end 596, and then fall therefrom into the open top containers on the lower conveyor 590 in an orderly manner.

In operation, crops dispensed by the crop dispensing unit 531 are disposed onto the upper transverse crop conveyor 595 and translated across the loading station 530 by the transverse crop conveyor 595. Simultaneously, a plurality of denested empty containers having open tops such as denested empty container 527 pass underneath the transverse crop conveyor 595 on the continuous conveyor system 536. As the crops disposed on the crop conveyor 595 reach the termination end 596, the crops fall into the open-top denested empty containers passing thereunder such as container 527. In this fashion, the denested empty containers are filled such as the filled container 532. The containers are thus filled with crops dispensed by the crop dispensing units, such as unit 531 that were freshly harvested by the harvester 512.

Considering now the translation station 535 in more detail and with reference to FIG. 7, translation station 535 serves the purpose of receiving filled containers such as filled container 532 and continually translating those containers seriatim to the container stacking apparatus 540. The translation station 535 may be in the form of a mechanical apparatus for translating the denested filled containers through a “U” shaped translation to the stacking apparatus 540. Alternatively, the translation of the containers may be performed manually by one or more operators.

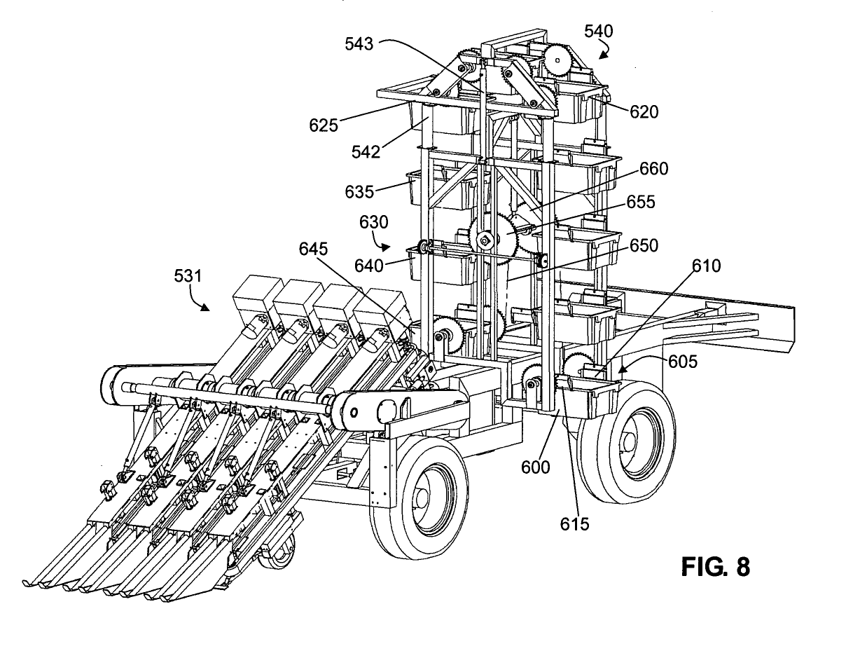

Considering now the container stacking apparatus 540 in more detail and with reference to FIG. 8, the container stacking apparatus continually receives seriatim a plurality of filled containers such as filled container 600 from the translation station 535 (see FIG. 7) and stacks those containers in a container stacking location shown generally at 630.

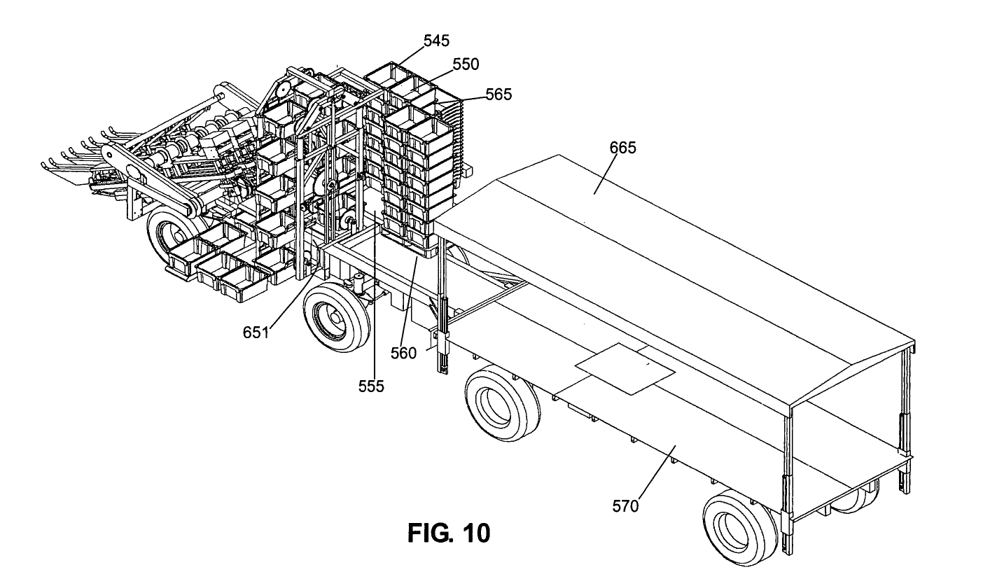

The container stacking apparatus includes a container infeed area shown generally at 605 for receiving filled containers such as filled container 600. The container stacking apparatus 540 further includes a series of grippers such as gripper 610 and 615 mechanically coupled to and spaced along a chain drive system shown diagrammatically at 650. The system 650 includes a chain 651, which is shown in part in FIG. 10, and which is configured in a closed loop. It should be understood that, while a chain drive is disclosed, other drives, such, for example, as belt drives, may also be employed. Grippers such as gripper 610 and 615 are generally horizontally opposed so that they may grip both sides of a filled container such as container 600. The grippers such as gripper 610 and gripper 615 are adapted to grip the lip of a filled container so that the container may be translated upwardly through the container stacking apparatus 540.

The apparatus 540 picks up one container after another and lifts them upwardly and then downwardly onto the top of the previous container. The motion of the apparatus is similar to a conventional “Ferris Wheel” amusement ride.

In operation, filled denested containers travel along a pre-determined path within the container stacking apparatus 540 held by the grippers and moved by the chain drive system 650. In particular, as a filled denested container 600 enters the container infeed area 605, it is gripped by grippers 610 and 615. The grippers that are being moved by the chain drive system 650 serve to raise the filled denested container 600 in an upward direction until it is proximate to the upper end of the frame 542 of the container stacking apparatus 540. At this point, the filled container such as the container 600 is translated horizontally to the top portion of the container stacking location or station shown generally at 630 which is generally located at least partially within the frame 542.

The filled container such as filled denested container 625 is then lowered into the container stacking station 630 such that the filled container 625 is placed seriatim on top of other filled and stacked containers such as 635, 640, and 645 that were previously lowered and stacked by the container stacking apparatus 540. After thus stacking, the container is released.

When a predetermined quantity of filled containers are stacked vertically in the container stacking location 630, such as eight, the stack of containers may be removed from the container stacking location 630 so that another stack of filled denested containers may be stacked in the container stacking location 630. The stack of filled containers in the container stacking location 630 is generally removed manually or may otherwise be removed by a mechanical apparatus (not shown). After the stack of filled containers are removed from the container stacking location 630 another stack of filled containers are then stacked in the container stacking location 630 in a continuous operation.

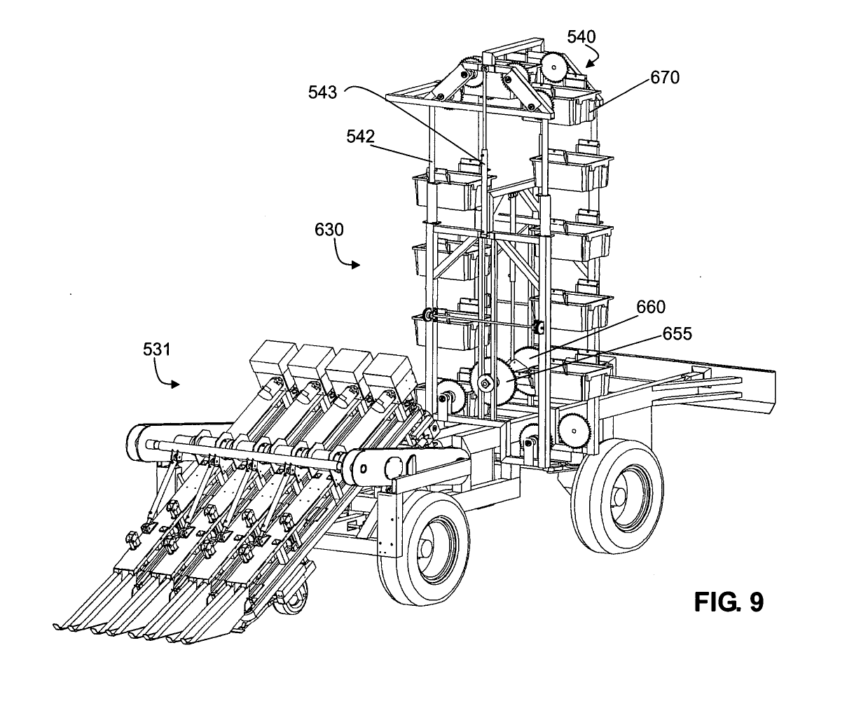

The container stacking apparatus 540 includes an extendable upright frame or structure 542, which supports the chain drive and which has the capability of elongating in the vertical direction through a telescoping mechanical apparatus. The telescoping mechanical apparatus is driven by piston cylinder assemblies such as hydraulic cylinders including cylinder 543 (FIGS. 8 and 9). In its elongated disposition, the frame 542 is raised from its retracted position.

Considering the chain drive system 650 of container stacking apparatus 540 in more detail with reference to FIG. 8, the chain drive system further includes a pair of take up wheels or sprockets 655 and 660 for a closed loop chain. The take up sprockets 655 and 660 are slidably and rotatably mounted to the frame 540 where the take up sprockets may be lowered relative to the extendable frame 542 to provide the dwell time to permit a stack to be discharged.

In general, the stacking apparatus 540 includes the upright structure 542 for supporting the chain drive system 650. The container receiving station and the container stacking station are disposed adjacent to one another at the structure 542. The chain drive system 650 has the chain 651 configured in the closed loop and the series of container grippers spaced therealong for grasping individual containers at the receiving station to translate containers upwardly from the receiving station seriatim and then downwardly toward the stacking station to position containers one at a time on top of previous containers to form a vertical stack. The moveably mounted take up sprocket coupled to the chain is adapted to move for adjusting the size of the loop of the chain.

In operation, after a predetermined quantity of containers have been stacked vertically at the stacking station 630, the take up sprocket moves downwardly to increase the effective size of the closed loop, and the structure substantially simultaneously extends vertically to accommodate the increased size of the chain loop for creating a longer translation path to increase dwell time for providing sufficient time to remove a completed stack of containers disposed at the stacking station from the structure before starting a new stack. Once the stack is removed from the stacking station and in order to return to normal operation, the take up sprockets return to their normal position as the structure retracts to its normal shorter size. Thus, sufficient tension is maintained on the chain 651 at all times.

With reference to FIG. 9, it should be understood that the instant harvesting support vehicle means and its related components described heretofore operate in a high speed manner where a row of crops which may be a considerable distance, such as about one-fourth mile long, are harvested in one continuous cycle and where containers are filled and stacked at a high rate of speed according to the apparatus and method of the present invention. In this regard, stacks of filled containers stored in the container stacking location 630 may be quickly removed so that another stack of filled containers may stack in the container stacking location 630. In order to provide more time for a manual operator or the mechanical apparatus to remove the stacks of filled containers stored in the container stacking location 630, the instant container stacking apparatus 540 contains a novel feature for increasing the dwell time of the system after the last filled denested container is stacked in the container stacking location 630 so that it may be removed without interfering with a subsequent stacking operation.

To increase the dwell time between the last filled container to be stacked in the container stacking location 630 and the first container to be placed in the container stacking location 630 for a subsequent stack that is to be created, the take up wheel 655 and 660 begins to descend down the frame of the container stacking apparatus 540 after the last container of the current stack is stacked within the container stacking location 630.

When the take up wheels descend the effect is to create slack in the chain 650 (see FIG. 8) which allows the frame 542 to extend upwardly. After the frame extends upwardly additional space may then be traversed by the filled containers such as filled container 670. Since additional space must be traversed by the subsequent container which is the first container to be stacked in the subsequent stack to be created, additional travel time is necessary which increases dwell time and permits sufficient time for the stack of filled containers in the container stacking location 630 to be removed.

After the stack of filled denested containers in the container stacking location 630 is removed, the frame 542 is retracted back into its normal operating position and take-up wheels 655 and 660 then return upwardly into their normal operating positions, thereby shortening the dwell time to provide speedy and efficient stacking of the filled containers in the container stacking location 630. This process continually repeats so long as filled containers are fed into the container stacking apparatus 540.

With reference to FIG. 10, stacks of filled containers such as filled container stacks 545 and 550 are placed either mechanically or through a manual operation onto the stacked filled container staging area 555. The filled container stacks, such as container stacks 545 and 550, after being staged in the filled container stack staging area 555, are then translated to an empty pallet 560. After a plurality filled container stacks are disposed on the pallet 560, the pallet is then translated to the pallet and container storage device 570.

The pallet and container storage device 570 is designed to receive a plurality of pallets each containing a plurality of filled container stacks as described for the previous embodiment heretofore. The pallet and container storage device 570 of the first or second embodiment may contain an awning or overhead covering 665 for shading purposes.

After the vehicle 500 is filled with a plurality of pallets each containing a plurality of filled container stacks, the vehicle 500 may be disconnected from the harvester 512 and driven or otherwise pulled to a crop processing area (not shown) and another support vehicle attached thereto containing empty pallets and containers for subsequent filling.

In another embodiment of the present invention the complete vehicle means having the pallet and container storage 570 attached thereto may be disconnected from the harvester 512 and driven under its own power to a location to further process the crops (not shown).

While the present embodiments of the invention is disclosed herein have been particularly shown and described with reference to particular embodiments thereof, it will be understood by those skilled in the art that various changes in form and details may be made therein without departing from the true spirit and scope of the present invention.

What is claimed is:

1. A method of loading harvested crops into individual containers being transported on vehicle means, comprising:
translating seriatim individual ones of the containers arranged in a series along at least one predetermined path of travel on the vehicle means to a loading station on the vehicle means;
translating loaded containers from the loading station to a stacking station on the vehicle means along the predetermined path of travel; and
translating stacked loaded containers to a storage station on the vehicle means.

2. A method as recited in claim 1, further including loading containers with the harvested crops at the loading station.

3. A method as recited in claim 1, further including storing a plurality of nested empty containers on the vehicle means.

4. A method as recited in claim 3, further including denesting the nested empty containers.

5. A method as recited in claim 1, further including continuously positioning the stacked loaded containers on the vehicle means.

6. A system for loading harvested crops into individual containers being transported on vehicle means, comprising:
means for translating seriatim individual one of the containers arranged in a series along at least one predetermined path of travel on the vehicle means to a loading station on the vehicle means;
means for translating loaded containers from the loading station to a stacking station on the vehicle means along the predetermined path of travel; and
means for translating loaded containers to a storage station on the vehicle means.

7. A system as recited in claim 6, further including means for loading containers with the harvested crops at the loading station.

8. A system as recited in claim 6, further including storing a plurality of nested empty containers on the vehicle means.

9. A system as recited in claim 8, further including denesting the nested empty containers.

10. A system as recited in claim 6, further including continuously positioning the stacked loaded containers on the vehicle means.

11. A harvesting support vehicle means for loading individual containers with harvested crops, comprising:
a receiving station disposed on the vehicle means for receiving empty individual containers;
a loading station disposed on the vehicle means for receiving empty nested containers from the receiving station and filling the empty nested containers with the harvested crops, thereby seriatim forming filled containers;
a stacking station disposed on the vehicle means for facilitating stacking the filled containers;
a continuous conveyor system interconnecting the receiving station, the loading station, and the stacking station; and
wherein containers disposed on the continuous conveyor system are translated seriatim along at least one predetermined path of travel on the vehicle means from the receiving station to the loading station, and are translated to the stacking station along a predetermined path of travel.

12. A harvesting support vehicle means as recited in claim 11, wherein the stacking station further includes:
an upright structure having an extendible portion;
a container receiving station disposed at the structure for receiving containers seriatim;
a container stacking station disposed at the structure opposite the container receiving station for assembling and stacking containers received seriatim by the container receiving system;
a chain drive disposed within the structure having a chain and a gripper for grabbing and translating containers from the container receiving station seriatim and through the container stacking station;
a slidably mounted take up sprocket coupled to the chain of the chain drive system; and
wherein, after a predetermined quantity of containers have been stacked within the container stacking station, the take up sprocket moves downwardly and the structure substantially simultaneously extends vertically for creating a larger translation path to increase dwell time in the apparatus for providing sufficient time to remove a stack of containers disposed within the container stacking station from the structure.

13. An object stacking apparatus, comprising:
an upright structure having an extendible portion;
an object receiving station disposed at the structure for receiving objects seriatim;
an object stacking station disposed at the structure opposite the object receiving station for assembling and stacking objects received seriatim from the object receiving system;
a chain drive disposed moveably mounted on the structure having a chain configured in a closed loop and a series of spaced apart grippers on the chain for grasping individual objects at the receiving station to translate objects upwardly from the object receiving station seriatim and then downwardly toward the object stacking station to position objects one at a time on top of previous objects to form a vertical stack;
a moveably mounted take up sprocket coupled to the chain of the chain drive system; and
wherein, after a predetermined quantity of objects have been stacked vertically at the object stacking station, the take up sprocket moves to increase the size of the closed loop and the structure substantially simultaneously extends to accommodate the increased size of the chain loop for creating a longer translation path to increase dwell time for providing sufficient time to remove a completed stack of objects disposed at the object stacking station from the structure before starting a new stack.

14. A harvesting container stacking apparatus as recited in claim 11, further including a walking beam for translating a plurality of empty nested containers to a denesting station.

15. A harvesting container stacking apparatus as recited in claim 14, further including
a harvester crop discharge device;
a first conveyor for receiving crops seriatim and translating the crops to the harvester crop discharge device;
a second conveyor disposed underneath the first conveyor and originating near the denesting station for receiving and conveying containers seriatim from the denesting station and conveying the containers underneath the exit portion of the first conveyor; and
wherein the crops travel along the first conveyor seriatim and fall into the containers as the crops traverse the termination end of the first conveyor.
